(19) United States
(12) Patent Application Publication
(10) Pub. No.: US 2016/0210647 A1
(43) Pub. Date: Jul. 21, 2016

(54) METHOD OF DETERMINING SEGMENTATIONS OF SUBSCRIBERS, NETWORK ENTITY USING THE SAME, AND SERVER USING THE SAME

(71) Applicants: Hsiao-Tse Chang, Taipei City (TW); Ta-Gang Chiou, Taipei City (TW)

(72) Inventors: Hsiao-Tse Chang, Taipei City (TW); Ta-Gang Chiou, Taipei City (TW)

(21) Appl. No.: 14/597,236

(22) Filed: Jan. 15, 2015

(51) Int. Cl. G06Q 30/02; H04W 4/02

(52) U.S. Cl. CPC G06Q 30/0205; H04W 4/02

(57) ABSTRACT

The present disclosure proposes a network entity, a server, and methods of determining the segmentations of the subscribers. In one of the exemplary embodiments, a network entity may receive a plurality of signaling messages of the plurality of subscribers, CDRs of the plurality of subscribers, and service contents of the plurality of subscribers, and obtain user information of the plurality of subscribers. The network entity may also obtain geolocation information of the plurality of subscribers by analyzing the plurality of signaling messages of the plurality of subscribers and obtain targeted geolocation information of each of the plurality of subscribers according to the CDRs and the service contents of each of the plurality of subscribers. The network entity may then, determine segmentations of each of the plurality of subscribers according to the geolocation information, the targeted geolocation information, and the user information of each of the plurality of subscribers.

### BACKGROUND OF THE DISCLOSURE

1. Field of the Disclosure

The present disclosure generally relates to a method of determining the segmentation of the subscribers, a network entity using the same method, and a server using the same method.

2. Description of Related Art

In recent years, electronic devices such as handsets or the smart phones have become highly sought after consumer electronics in the market. In addition, numerous functions have been integrated into these handsets by manufactures in order to entice consumers and to satisfy consumers' needs. For example, users could capture images, make phone calls, or surf the Internet by using handsets. Also, the Global Positioning System (GPS) and electronic map are also very popular functions in handsets such that users may obtain their locations by using a positioning function of handsets.

On the other hand, by combining with the positioning function of the handsets, mobile advertising has become a popular way of advertising a company's products and enterprise image. Traditionally, the location information could be retrieved from handsets or installed applications for mobile advertisings. However, there could be lots of limitations of traditional approaches for practical use. For example, first, the location information may only be retrieved while the location service is supported or enabled by a smart phone, but feature phones may not support the location service. Second, in an indoor environment without effective GPS satellite signals, the location accuracy would usually be very poor even though it has been estimated that more than 70% of handset uses occurs in indoors. Third, location information may only be retrieved while an application is opened or with the background running. Forth, the complete location information that a subscriber visits every day may not be tracked. Accordingly, there could a need for a method and a device to improve the aforementioned limitations and to evaluate the geolocation utilization of the mobile advertising.

### SUMMARY OF THE DISCLOSURE

Accordingly, the present disclosure is directed to a method of determining the segmentations of the subscribers, a network entity using the same, and a server using the same, thereby obtaining individual subscriber location, experience, context, and lifestyle, and eventually deriving the marketing segmentation for mobile advertising or market research purpose.

In particular, the present disclosure proposes a network entity that includes at least but not limited to a transceiver circuit, a storage medium, and a processor coupled to the transceiver circuit and the storage. The transceiver circuit is configured for receiving a plurality of signaling messages of a plurality of subscribers, call detail records (CDRs) of the plurality of subscribers, and service contents of the plurality of subscribers. The storage medium is configured for storing user information of the plurality of subscribers. The processor is coupled to the transceiver circuit and the storage medium, and is configured for obtaining geolocation information of the plurality of subscribers by analyzing the plurality of signaling messages of the plurality of subscribers, obtaining targeted geolocation information of each of the plurality of subscribers according to the CDRs and the service contents of each of the plurality of subscribers, and determining segmentations of each of the plurality of subscribers according to the geolocation information, the targeted geolocation information, and the user information of each of the plurality of subscribers.

The present disclosure proposes a method of determining segmentations of a plurality of subscribers used by a network entity, to perform including at least but not limited to receiving a plurality of signaling messages of the plurality of subscribers, CDRs of the plurality of subscribers, and service contents of the plurality of subscribers, and obtaining user information of the plurality of subscribers, obtaining geolocation information of the plurality of subscribers by analyzing the plurality of signaling messages of the plurality of subscribers, obtaining targeted geolocation information of each of the plurality of subscribers according to the CDRs and the service contents of each of the plurality of subscribers, and determining segmentations of each of the plurality of subscribers according to the geolocation information, the targeted geolocation information, and the user information of each of the plurality of subscribers.

The present disclosure proposes a server that includes at least but not limited to a transceiver circuit, a storage medium, and a processor. The transceiver circuit is configured for receiving a plurality of signaling messages of a plurality of subscribers, call detail records (CDRs) of the plurality of subscribers, and service contents of the plurality of subscribers. The storage medium is configured for storing user information of the plurality of subscribers. The processor is coupled to the transceiver circuit and the storage medium, and is configured for obtaining geolocation information of the plurality of subscribers by analyzing the plurality of signaling messages of the plurality of subscribers, obtaining targeted geolocation information of each of the plurality of subscribers according to the CDRs and the service contents of each of the plurality of subscribers, and determining segmentations of each of the plurality of subscribers according to the geolocation information, the targeted geolocation information, and the user information of each of the plurality of subscribers.

In order to make the aforementioned features and advantages of the present disclosure comprehensible, exemplary embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram illustrating a communication system in accordance with an exemplary embodiment of the present disclosure.

FIG. 2 is a block diagram illustrating the network entity in accordance with an exemplary embodiment of the present disclosure.

FIG. 3 is a flow chart illustrating a method for determining segmentations of subscribers of the network entity of the mobile operator according to an exemplary embodiment of the disclosure.

FIG. 4 is a flow chart illustrating a method for determining the sticky locations according to an exemplary embodiment of the disclosure.

FIG. 5 is a flow chart illustrating a method for calculating the commute data according to an exemplary embodiment of the disclosure.

FIG. 6 is a schematic diagram illustrating a communication system in accordance with another exemplary embodiment of the present disclosure.

FIG. 7 is a block diagram illustrating the server in accordance with an exemplary embodiment of the present disclosure.

FIG. 8 is a flow chart illustrating a method for determining segmentations of subscribers of the server according to an exemplary embodiment of the disclosure.

FIG. 9 is a flow chart illustrating a method for determining segmentations of subscribers of the network entity or the server.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

In this disclosure, 3GPP-like keywords or phrases are used merely as examples to present inventive concepts in accordance with the present disclosure; however, the same concept presented in the disclosure can be applied to any other systems such as IEEE 802.11, IEEE 802.16, WiMAX, and so like by persons of ordinarily skilled in the art.

For second generation (2G) such as Global System for Mobile (GSM) or Code Division Multiple Access (CDMA), third generation (3G) such as Universal Mobile Telecommunications System (UMTS), CDMA2000, or Time-Division-Code Division Multiple Access (TD-CDMA), forth generation (4G) such as Long-Term Evolution (LTE) or Worldwide Interoperability for Microwave Access (WiMAX), and coming fifth generation (5G) mobile networks, the series of signaling protocol specification for the communication between handsets, a base station (or a cell site) and the core network are defined by Third Generation Partnership Project (3GPP). By utilizing the signaling messages, there are lots of geolocation methods such as trilaterization (or trilateration), triangulation, multilateration, and proprietary methods for geolocation. Accordingly, the present disclosure proposes a systematic method for tagging location, user experience, context, and lifestyle of each subscriber based on the geo-location results and hence derives the marketing segmentation tags of each individual subscriber.

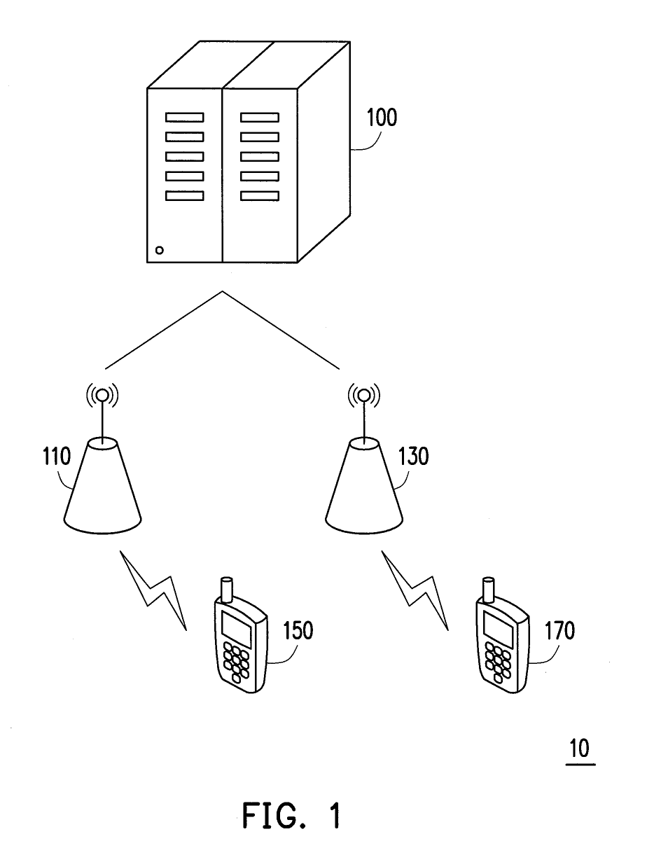

FIG. 1 is a schematic diagram illustrating a communication system in accordance with an exemplary embodiment of the present disclosure. Referring to FIG. 1, the communication system 10 could include but not limited to a network entity 100, base stations (BSs) 110 and 130, and user equipments (UEs) 150 and 170.

The BSs 110 and 130 in this disclosure could represent various embodiments which for example could include but not limited to a Home Evolved Node B (HeNB), an eNB, an advanced base station (ABS), a base transceiver system (BTS), an access point, a home base station, a relay station, a scatterer, a repeater, an intermediate node, an intermediary, and/or satellite-based communications base stations.

The UEs 150 and 170 in this disclosure could represent various embodiments which for example could include but not limited to a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, and so like. In some applications, a UE may be a fixed computer device operating in a mobile environment, such as a bus, train, an airplane, a boat, a car, and so forth.

The network entity 100 in this disclosure could represent various embodiments which for example could include but not limited to a Serving Gateway (S-GW), a Packet Data Network Gateway (P-GW), a Serving GPRS Support Node (SGSN), a Gateway GPRS Support Node (GGSN), and/or any entity in the Evolved Packet Core (EPC).

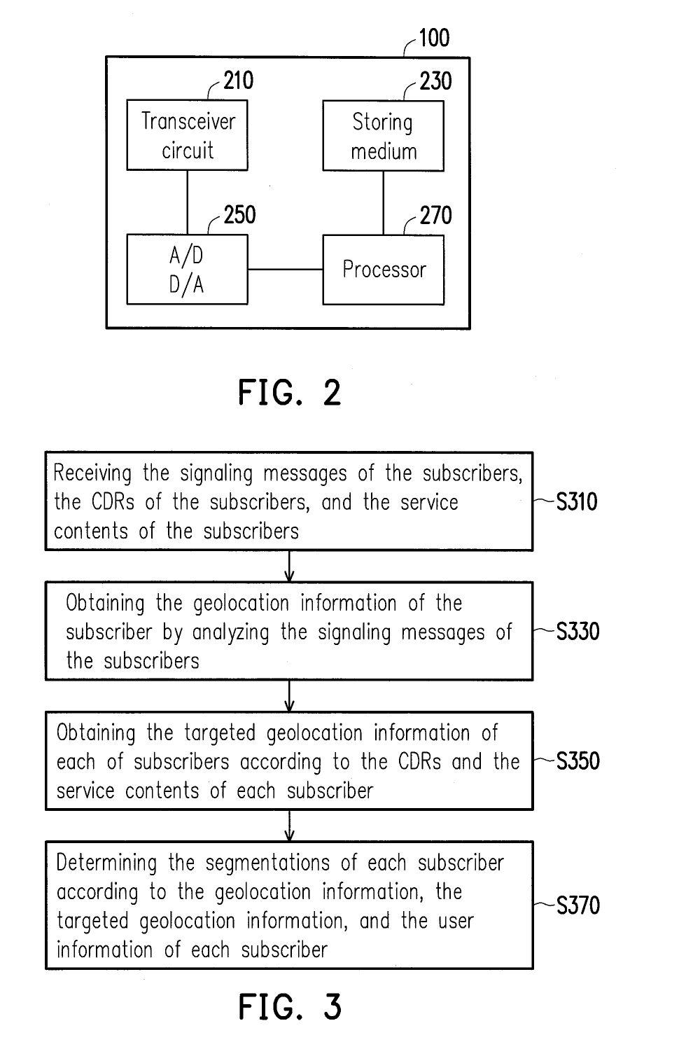

The network entity 100 is coupled to the BSs 110 and 130 respectively through wired backhaul interface such as digital subscriber lines (DSL), cable, or fiber, or wireless connection such as the microwave transmission or the satellite communication, to communicate with BSs 110 and 130. FIG. 2 is a block diagram illustrating the network entity 100 in accordance with an exemplary embodiment of the present disclosure. The network entity 100 includes at least a transceiver circuit 210, a storage medium 230, an analog-to-digital (A/D)/digital-to-analog (D/A) converter 250, a processor 270, optionally one or more antenna units (not shown) for the microwave transmission or the satellite communication.

The transceiver circuit 210 may be coupled to for example but not limited the interfaces A and Abis of 2G base station controller (BSC), the interfaces Iub, IuCS and IuPS of 3G radio network controller (RNC), the interfaces UU air, X2, S1 of 4G eNodeB, LTE Direct, and/or WiFi Access Point (AP), to transmit and/or receive signals such as 3GPP signaling messages or data. The transceiver circuit 210 may be also coupled to for example but not limited a core network probe or a deep packet inspector (DPI) on the 3G interfaces Gn, Gi, the 4G interfaces S1-U, S11, S5, or Internet Protocol (IP) sniffer, to receive service contents (or metadata) derived from the website or the application service the subscriber (i.e. the user of the UE 150 or 170) of the mobile operator is visiting or browsing. In other words, the service contents of the subscribers are parsed by a deep packet inspector. Besides, the transceiver circuit 210 may be also coupled to for example but not limited a billing database or a mediation device of the mobile operator, to receive Call detail records (CDRs). The CDRs may contain the caller and callee information, such as the mobile station integrated services digital network number (MSISDN) or the international mobile subscriber identity (IMSI).

In some embodiments, the transceiver circuit 210 may also perform operations such as low noise amplifying, impedance matching, frequency mixing, up or down frequency conversion, filtering, amplifying, and so like.

The storage medium 230 may be, for example, a memory, a hard drive, or any element. The storage medium 230 stores a plurality of user information such as gender, age, income, occupation, family members, Average Revenue Per User (ARPU), billing address, plan value added services of each subscriber. In addition, after receiving the signaling messages, the CDRs, or the service contents of each subscriber by the transceiver circuit 210, the signaling messages, the CDRs, or the service contents may be stored in the storage medium 230.

It should be noted that, in some embodiments, these user information of the subscribers may be stored in the external database or other network entity, so that these user information of the subscribers may be received by the transceiver circuit 210.

The analog-to-digital (A/D)/digital-to-analog (D/A) converter 250 is configured to convert from an analog signal format to a digital signal format during uplink signal processing and from a digital signal format to an analog signal format during downlink signal processing.

The processor 270 may be, for example, a general purpose processor, a special purpose processor, a conventional processor, a digital signal processor, a plurality of microprocessors, a microprocessor combining one or more digital signal processor cores, a controller, a microcontroller, a application specific integrated circuit (ASIC), a FPGA, a DSP chips, any other kind of integrated circuit, a state machine, a processor based on an advanced RISC machine (ARM), or the like, and the processor 270 may also be implemented with either hardware or software. The processor 270 is coupled to the A/D and D/A converter 250 and the storage medium 230. The processor 270 is configured to process digital signal and to perform procedures of the proposed method in accordance with exemplary embodiments of the present disclosure. Also, the processor 270 may store programming codes, device configurations, a codebook, buffered or permanent data, and records a plurality of modules that can be executed by the processor 270.

FIG. 3 is a flow chart illustrating a method for determining segmentations of subscribers of the network entity 100 of the mobile operator according to an exemplary embodiment of the disclosure. Referring to FIG. 3, in step S310, the signaling messages of the subscribers, the CDRs of the subscribers, and the service contents of the subscribers are received by the processor 270 through the transceiver circuit 210, and the user information of the subscribers are obtained from the storage medium 230. The above descriptions of the transceiver circuit 210 and the storage medium 230 could be referred to the receiving and obtaining methods in the step S310, and therefore detailed descriptions for each step will not be repeated.

Next, in step S330, the geolocation information of the subscribers is obtained by analyzing the signaling messages of the subscribers using the processor 270. In one embodiment of the disclosure, the geolocation information of the subscribers comprises locations, such as the latitude and the longitude of the position, quality of experiences (QoEs) at the locations, such as drop date, throughput, volume, radio frequency (RF) conditions, etc. . . . , and moving behaviors of the subscribers, such as environment (indoor/outdoor), moving speed, moving direction, Point of Interest (PoI), etc. . . . .

For example, the signalling messages may be the measurement reports. The signal strength such as received signal code power (RSCP) or Received Signal Strength Indication (RSSI) in the measurement reports could be obtained by the processor 270, and the trilaterization process would be performed according to the signal strength, to determine the position of the subscriber (UE 150 or 170). After determining the position of the subscriber, the moving direction and moving speed could be calculated according to the history geolocation data recorded within a period time such as 10 minutes, an hour, or a day. Accordingly, the historical moving pattern of the subscribers would be learned. It should be noted that, the method and the algorithm for positioning could be the triangulation, multilateration, or any other positioning method and the algorithm, and the timing related information such as timing relative event could be obtained for calculating the position of the subscriber, the present disclosure is not limited to the positioning method.

In another example, the user experience comprises data volume, data throughput, wireless side radio experience, etc. . . . which could be derived and aggregated from the 3GPP signalling events.

In other example, the PoI is systematically looked up from electronic map application programming interface (API) providers, such as Google map, Bing, open Street Map, etc. Specifically, a threshold D_{T} could be determined by the mobile operator or could be pre-determined. The threshold D_{T} is the threshold distance between candidate entity location L_{C} from map API query and the geolocation L_{G} calculated by the aforementioned positioning method. Next, the average neighboring site distance D_{avg(n)} could be calculated, and D_{T} is set as W*D_{avg(n)} by the processor 270 while W is defined between a range of 0 to 0.5. Subsequently, the candidate entity location L_{C} and the Min(D(L_{C}, L_{G})) which is the minimum distance between the candidate entity location L_{C} and the geolocation L_{G} could be selected as the PoI location.

In some examples, the history geolocation data also input to the aforementioned algorithm of determining the PoI in order to refine the geolocated location based on the knowledge of historical moving pattern of the subscribers.

After collecting the CDRs and the service contents of the subscribers, in step S350, the targeted geolocation information of each of subscribers are obtained by the processor 270 according to the CDRs and the service contents of each subscriber.

In one embodiment of the disclosure, the targeted geolocation information of each subscriber comprises targeted entities related information of each subscriber, and the targeted entities related information of each subscriber is obtained according to the CDRs or the service contents of each subscriber. A CDR of a subscriber or a service content corresponding to a targeted entity is generated when the subscribers makes or receives a call (or short message (SMS)) to/from the targeted entity, or a service content of the subscriber is provided by another targeted entity. In addition, the segmentations of each subscriber may also be determined according to the targeted entities related information.

For example, the processor 270 may identify the MSISDN or IMSI of the other party from the CDR whenever voice calls or SMS are made. By looking up the yellow pages using the MSISDN or IMSI, the targeted entity of the other party, such as a company, a restaurant, a store, etc. . . . , may be identified by the processor 270. Through the category in yellow pages, the interest of the subscribers, such as the subscriber is a movie lover, a music lover, and Italian food lover, a fast food lover, etc. . . . , may be identified by the processor 270. Aggregating the CDRs lookup result for a certain period of time such as 12 hours or a day, the segmentation tags of each scriber would be generated.

In another example, the targeted uniform resource locator (URL), the targeted service, or the targeted application may be identified from the DPI by the processor 270 while data traffic is generated from the subscriber (UE 150 or 170). By looking up the URL yellow pages or databases using the targeted URL, the targeted service, or the targeted application, the targeted entity of the other party, such as a company, a restaurant, a store, etc. . . . , may be identified by the processor 270. Through the category in yellow pages, the interest and action of the subscribers may be identified by the processor 270. Aggregating the DPIs lookup result for a certain period of time such as 12 hours or a day, the segmentation tags of each scriber would be generated.

In other embodiment of the disclosure, the targeted geolocation information of each subscriber comprises location information of the targeted entities of each subscriber, and the location information of the targeted entities of each subscriber may be obtained according to the CDRs or the service contents of each subscriber, and visiting locations of each subscriber according to the location information of the targeted entities of each subscriber may be predicted by the processor 270.

For example, by looking up the yellow pages using the MSISDN, IMSI, the URL, the service, or the application, the address of the targeted entity may also be obtained by the processor 270. The latitude and longitude of the targeted entity may obtained through the address geocoding API, therefore the potential subscriber visiting location in the future such as 1 month may also be predicted by the processor 270.

In another embodiment of the disclosure, a geolocation accuracy of the processor is refined according to the location information of the targeted entities and the geolocation information of the subscribers in response to a subscriber is near the targeted entity of the subscriber.

For example, once the subscriber visits nearby area of the targeted entity of the subscriber within the time period such as 20 days or 40 days, the geocoding result will also be feed in geolocation module of the processor 270 to refined the geolocation accuracy and make it become a deep learning system. Specifically, the threshold D_{T2} could be determined by the mobile operator or could be pre-determined. The threshold D_{T2} is the threshold distance between targeted entity location L_{T} from the geocoding result and the geolocation L_{G2} calculated by the aforementioned positioning method. Next, the average neighboring site distance D_{avg(n)2} could be calculated, and D_{T2} is set as W2*D_{avg(n)2} by the processor 270 while W2 is defined between a range of 0 to 0.5. Subsequently, if the distance D(L_{T}, L_{G2}) which is the distance between the targeted entity location L_{T} and the geolocation L_{G2} is less than the threshold D_{T2}, the geolocation L_{G2} is refined as the targeted entity location L_{T}.

After collecting the locations, the QoEs at the locations, and the moving behaviors of the subscribers, in step S370, the segmentations of each subscriber are determined by the processor 270 according to the geolocation information, the targeted geolocation information, and the user information of each subscriber. In a scenario, the subscriber may stay at different places every day, therefore the present disclosure may also estimate these places by the history geolocation data of each subscriber and calculate the commute data among these places. Accordingly, in one embodiment of the disclosure, the geolocation information of each subscriber is recorded in a history geolocation data of each subscriber. Next, the sticky locations of each subscriber which are clustering centers of the geolocation information of each subscriber are determined according to the history geolocation data of each subscriber. Subsequently, the building categories nearby the sticky locations of each subscriber may be identified.

Specifically, the geolocation information may be recorded for a certain period of time such as a day, 1 week, or a month. For example, location of the subscriber can be derived 24 by 7 as long as there is any activity on the UE (UE 150 or 170), such as voice call, SMS, data session, application background data, etc. . . . . Then, the sticky locations are determined by algorithms such as probability function with Gaussian distribution or Density-Based Spatial Clustering of Applications with Noise (DBSCAN) which is used to find the clustering centers of all locations of mobile phone services every day.

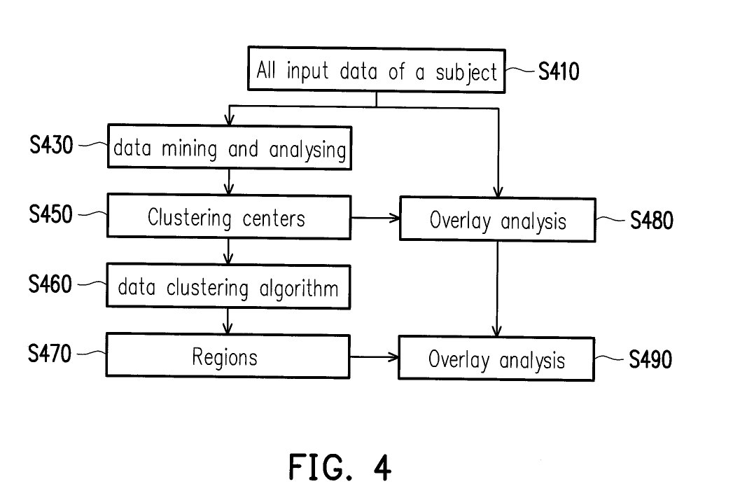

For example, FIG. 4 is a flow chart illustrating a method for determining the sticky locations according to an exemplary embodiment of the disclosure. Referring to FIG. 4, in step S410, all input data of a subject. In this example, the history geolocation data may be input for calculating. Next, a data mining and analyzing algorithm such as the daily DBSCAN algorithm, Alex Rodriguez (A. Rod.) fast clustering algorithm, ordering points to identify the clustering structure (OPTICS), and so forth is performed by the processor 270 according to the input data (step S430), to determining the clustering centers (step S450). For example, the DBSCAN algorithm may comprise for example but not limited to the following steps, labeling all pints as center, border, or noise points, eliminating noise points, putting an edge between all center points that are within a scan radius Eps of each other, making each group of connected center points into a separate cluster, and assigning each border point to one of the clusters of its associated center point. Then, the processor 270 may determine whether the clustering centers are overlapped (step S480). After determining the clustering centers, a data clustering algorithm such as A. Rod. fast clustering algorithm, k-means algorithm and so forth may be performed by the processor 270 (step S460), and then the regions would be determined (step S470). Subsequently, the processor 270 may determine whether the clustering centers are overlapped again (step S490).

It should be noticed that, the aforementioned algorithms, such as DBSCAN, A. Rod. fast clustering algorithm, and etc, are merely for example, the embodiment of the disclosure is not limited to the algorithms for determining the clustering centers and regions. Besides, in other embodiment, A. Rod. fast clustering algorithm performed at step S460 may be performed at graph database.

Next, by looking up the electronic map APIs, the nearby location or the building categories S_{L} may be identified. Specifically, the threshold D_{T3} could be determined by the mobile operator or could be pre-determined. The threshold D_{T3} is the threshold distance between candidate entity location L_{C3} from the electronic map query and the geolocation L_{G3} calculated by the aforementioned positioning method. Next, the average neighboring site distance D_{avg(n)3} could be calculated, and D_{T3} is set as W2*D_{avg(n)3} by the processor 270 while W3 is defined between a range of 0 to 0.5. Subsequently, the candidate entity location L_{C3} and the Min(D(L_{C3}, L_{G3})) which is the minimum distance between the candidate entity location L_{C} and the geolocation L_{G} could be selected as the building category S_{L} and the targeted sticky location, respectively. The building category S_{L} is generated as subscriber interest or segmentation.

In addition, the segmentation tags of each subscriber may be generated by applied the aforementioned DBSCAN algorithm repeatedly.

In another embodiment of the disclosure, the frequently visiting locations of each subscriber according to the sticky locations of each subscriber. Next, the commute data of each subscriber which each subscriber moves among the frequently visiting locations of each subscriber are calculated according to the history geolocation data of each subscriber.

For example, the subscriber daily moving pattern is generated from certain of history geolocation data. Specifically, home location L_{H}, office location L_{O}, and other frequent visited locations L_{F(1)}, . . . , L_{F(n)} are determined from the sticky locations determined by the aforementioned algorithm. The processor 270 may determine that one of the sticky locations which the subscriber stays, for example, from 10 P.M. to 6 A.M. is the home location L_{H} of the subscriber, or another sticky location which the subscriber stays, for example, from 9 A.M. to 5 P.M. is the office location L_{O}.

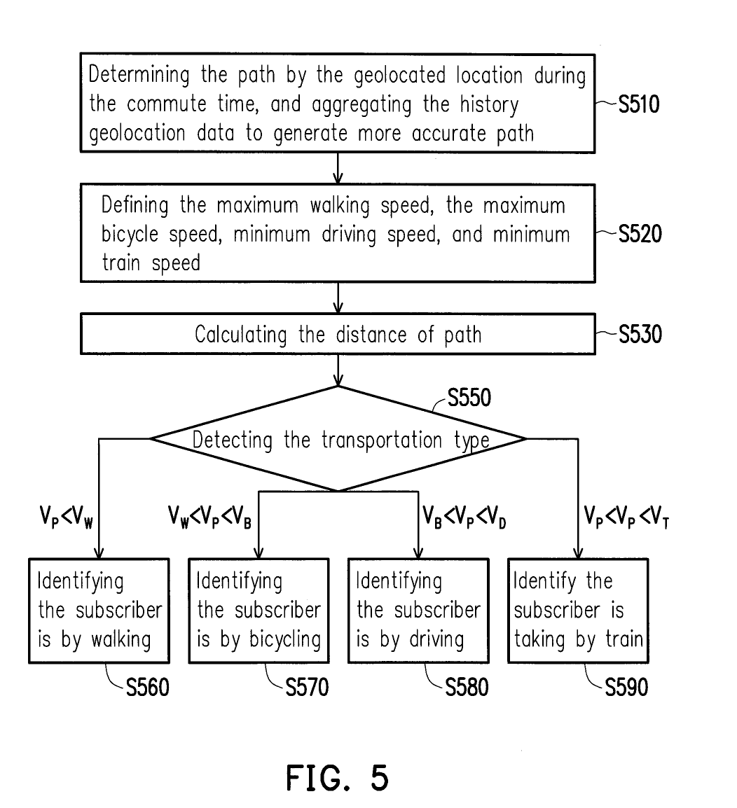

Then, the commute data of each subscriber such as a commute time (T(L_{O}) to T(L_{H})), a commute path P(L_{H}, L_{O}), and a (public) transportation type of each subscriber could be calculated by the processor 270. For example, FIG. 5 is a flow chart illustrating a method for calculating the commute data according to an exemplary embodiment of the disclosure. Referring to FIG. 5, in step S510, The path P(L_{H}, L_{O}) is determined by all the geolocated location during the commute time T(L_{O}) to T(L_{H}) and the history geolocation data are aggregated to generate more accurate path. Next, in step S520, the maximum walking speed V_{W}, the maximum bicycle speed V_{B}, minimum driving speed V_{D}, and minimum train speed V_{T} are defined. Then, in step S530, the distance of path P(L_{H}, L_{O}) is calculated as D_{P}, and the moving speed from the home location L_{H} to the office location L_{O} is V_{P}=D_{P}/(T(L_{O})−T(L_{H})). Subsequently, the transportation type is further detected by the processor 270 (S550). According to the network topology provided by the mobile network operators, those Metro cells could be identified by the processor 270, and hence which vehicle such as metro or subway underground that the subscriber are transported could be determined. If V_{P}<V_{W}, then the processor 270 may identify the subscriber is by walking (step S560). If V_{W}<V_{P}<V_{B}, then the processor 270 may identify the subscriber is by bicycling (step S570). If V_{B}<V_{P}<V_{D}, then the processor 270 may identify the subscriber is by driving (or car) (step S580). If V_{D}<V_{P}<V_{T}, then the processor 270 may identify the subscriber is taking by train (step S590).

Accordingly, the daily moving pattern of each subscriber would be determined, so as to distinguish the weekday pattern and the weekend pattern. For example, there is not existed the office location (L_{O}) in the weekend pattern. In some embodiments, the foreigner roaming pattern may also be identified by the aforementioned methods of determining sticky locations and calculating the commute data.

Subsequently, by collecting with all the identified segmentation and pattern from the aforementioned steps for determining the geolocation information, the targeted geolocation information, the sticky locations, the moving pattern of each subscriber, in one embodiment of the disclosure, the lifestyle of each subscriber are determined according to the segmentations of each subscriber.

For example, a lifestyle list may be generated by the processor 270. Table (1) is an example of the lifestyle list. The processor 270 may select one or more lifestyle items from the lifestyle list to each subscriber based on the geolocation information, the targeted geolocation information, the sticky locations, and the moving pattern of each subscriber.

TABLE (1)

| Business | Travel | Shopping | Sports | Entertainment | |
|---|---|---|---|---|---|
| Business | Business | Catalog | Sports | Bookworms | Music lovers |
| professionals | travellers | shopper | fans | | |
| Personal | Flight | In-app | Avid | Casual and | News and |
| finance geeks | intenders | purchasers | runners | social games | magazine |
| | | | | | readers |
| Real estate | Leisure | Online | American | Entertainment | Slots players |
| follower | traveller | shoppers | football | enthusiasts | |
| | | | fans | | |
| Small business | | Mobile | Basketball | Hardcore/mid- | TV lovers |
| owner | | payment | fans | core gamers | |
| | | makers | | | |
| | | Value | Baseball | Movie lovers | |
| | | shoppers | fans | | |

Lifestyle

| | | | | | |
|---|---|---|---|---|---|
| American | Avid | Engineering | Food and | New mothers | Pet owners |
| football | runners | enthusiasts | garden pros | | |
| Auto | Nature | Fashionistas | Mothers | Parenting and | Photo and |
| enthusiasts | lovers | | | education | video |
| | | | | | enthusiasts |
| Singles | Social | Spanish | Sports | Tech and | |
| | Influencer | Speakers | fans | gadget | |
| | | | | enthusiasts | |

Accordingly, the mobile operators may learn where the subscriber have been or what the subscriber are interested in, and the mobile operators can provides those segmentations or lifestyles of each subscriber to the third party platforms to generate more business value.

For example, the third party platform may be the mobile advertising (AD) platform. The mobile advertising platform is usually integrated with AD network, data management platforms (DMPs), or demand side platforms (DSPs), to provide advertisers better targeted accuracy to their customers.

In another example, the third party platform may be the market research. Since all the segmentation are already in the network entity 100, the network entity 100 can also integrated with market research entity to help market research more efficient, such as saving huge human effort and cost to conduct polling, and effective, such as much higher validity and reliability.

In other example, the third party platform may be Urban planning. The network entity 100 may provide sustainable planning such as healthcare infrastructure improvement, transportation planning, etc. . . . .

In other example, the third party platform may be Customer Relationship Management (CRM). The network entity 100 may be integrated with enterprise CRM system to help enterprise better understands their customers.

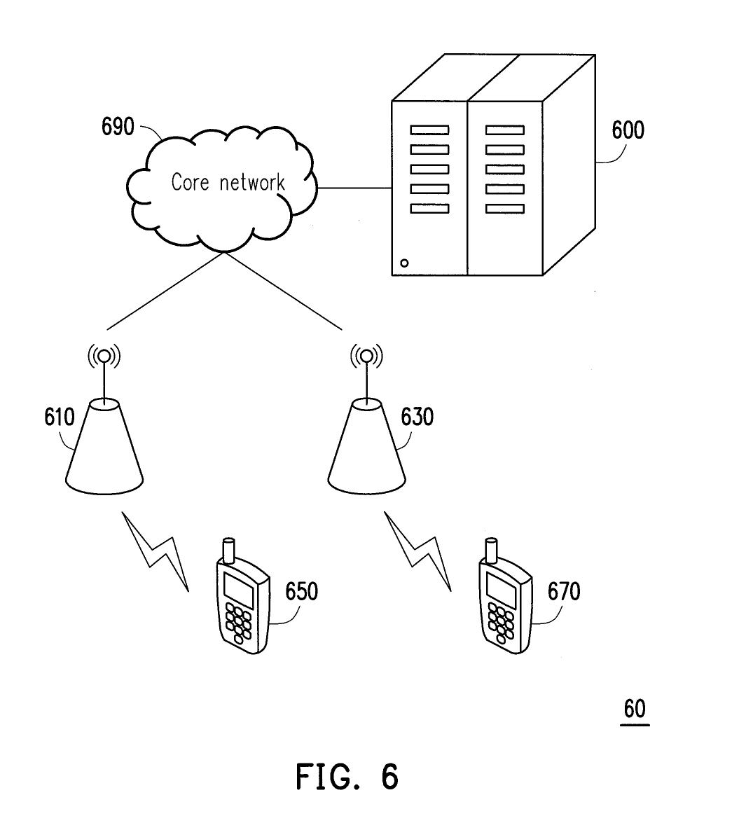

On another view of the present disclosure, the FIG. 6 is a schematic diagram illustrating a communication system in accordance with another exemplary embodiment of the present disclosure. Referring to FIG. 6, the communication system 60 could include but not limited to a server 600, BSs 610 and 630, UEs 650 and 670, and a core network 690.

The exemplary embodiments of the BSs 610, 630 and the UEs 650, 670 is similar to the BSs 110, 130 and the UEs 150, 170, respectively, and therefore detailed descriptions for the BSs 610, 630 and the UEs 650, 670 will not be repeated.

The core network 690 may be, for example, a Serving Gateway (S-GW), a Packet Data Network Gateway (P-GW), a Serving GPRS Support Node (SGSN), a Gateway GPRS Support Node (GGSN), and/or any entity in the Evolved Packet Core (EPC), the combination of those examples, or 2G core network such as GPRS core network, 3G core network, or 4G core network such as EPC.

The server 600 in this disclosure could represent various embodiments which for example could include but not limited to a service capability server (SCS), a file server with computing capability, a database server, an application server, a work station or a person computer, whose type is not limited in the disclosure. The server 600 is coupled to the core network 690 through wired backhaul interface such as DSL, cable, or fiber, or wireless connection such as the microwave transmission or the satellite communication, to communicate with the core network 690.

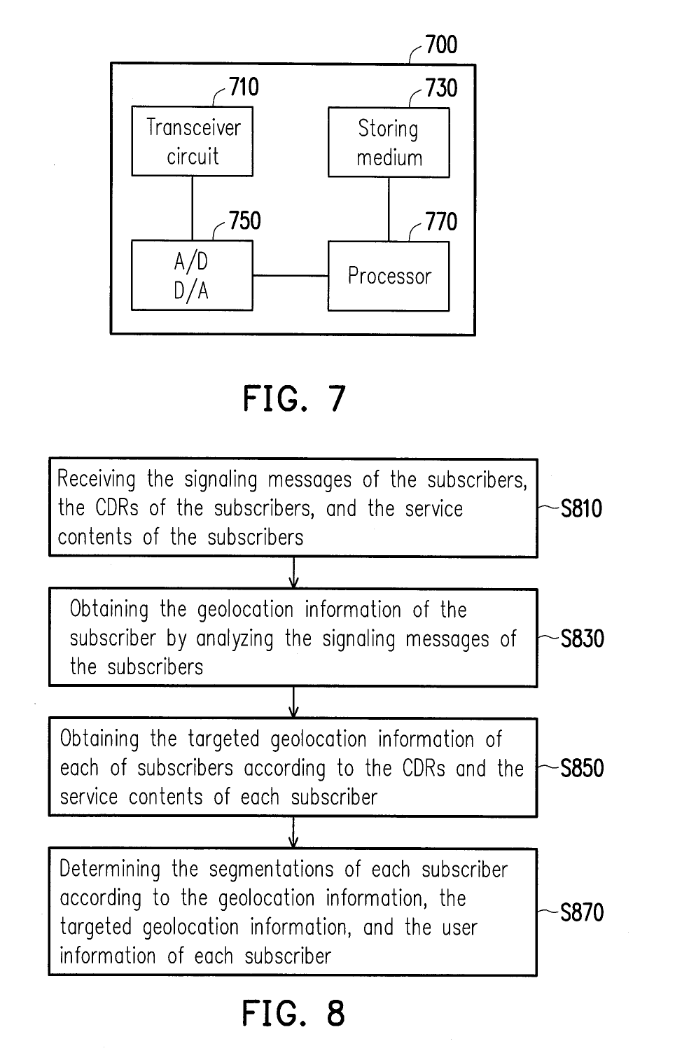

FIG. 7 is a block diagram illustrating the server 600 in accordance with an exemplary embodiment of the present disclosure. The server 600 includes at least a transceiver circuit 710, a storage medium 730, an analog-to-digital (A/D)/digital-to-analog (D/A) converter 750, a processor 770, optionally one or more antenna units (not shown) for the microwave transmission or the satellite communication. The function of each element of the server 600 is similar to the network entity 100, and therefore detailed descriptions for each element will not be repeated.

In addition, the different function between the transceiver circuit 710 of the server 600 and the transceiver circuit 210 of the network entity 100 is, the transceiver circuit 710 may be coupled to for example but not limited the interfaces A and Abis of 2G base station controller (BSC), the interfaces Iub, IuCS and IuPS of 3G radio network controller (RNC), the interfaces UU air, X2, S1 of 4G eNodeB, LTE Direct in the core network 690, and/or WiFi Access Point (AP), to transmit and/or receive signals such as 3GPP signaling messages or data. The transceiver circuit 710 may be also coupled to for example but not limited a core network probe or a deep packet inspector (DPI) on the 3G interfaces Gn, Gi, the 4G interfaces S1-U, S11, S5, or Internet Protocol (IP) sniffer in the core network 690, to receive service contents (or metadata) derived from the website or the application service the subscriber (i.e. the user of the UE 150 or 170) of the mobile operator is visiting or browsing. Besides, the transceiver circuit 710 may be also coupled to for example but not limited a billing database or a mediation device of the mobile operator in the core network 690, to receive the CDRs.

FIG. 8 is a flow chart illustrating a method for determining segmentations of subscribers of the server 600 according to an exemplary embodiment of the disclosure. Referring to FIG. 8, in step S810, the signaling messages of the subscribers, the CDRs of the subscribers, the service contents of the subscribers, and the user information of the subscribers are received by the processor 670 through the transceiver circuit 610 from the core network 690, and these information of the subscribers are stored in the storage medium 730. Next, in step S830, the geolocation information of the subscribers are obtained by analyzing the signaling messages of the subscribers using the processor 670. After collecting the CDRs and the service contents of the subscribers, in step S850, the targeted geolocation information of each of subscribers are obtained by the processor 670 according to the CDRs and the service contents of each subscriber. Subsequently, in step S870, the segmentations of each subscriber are determined by the processor 670 according to the geolocation information, the targeted geolocation information, and the user information of each subscriber. It should be noted that, the operation steps of the step S810˜S870 is similar to the step S310˜S370, respectively, and therefore detailed descriptions for each operation step will not be repeated.

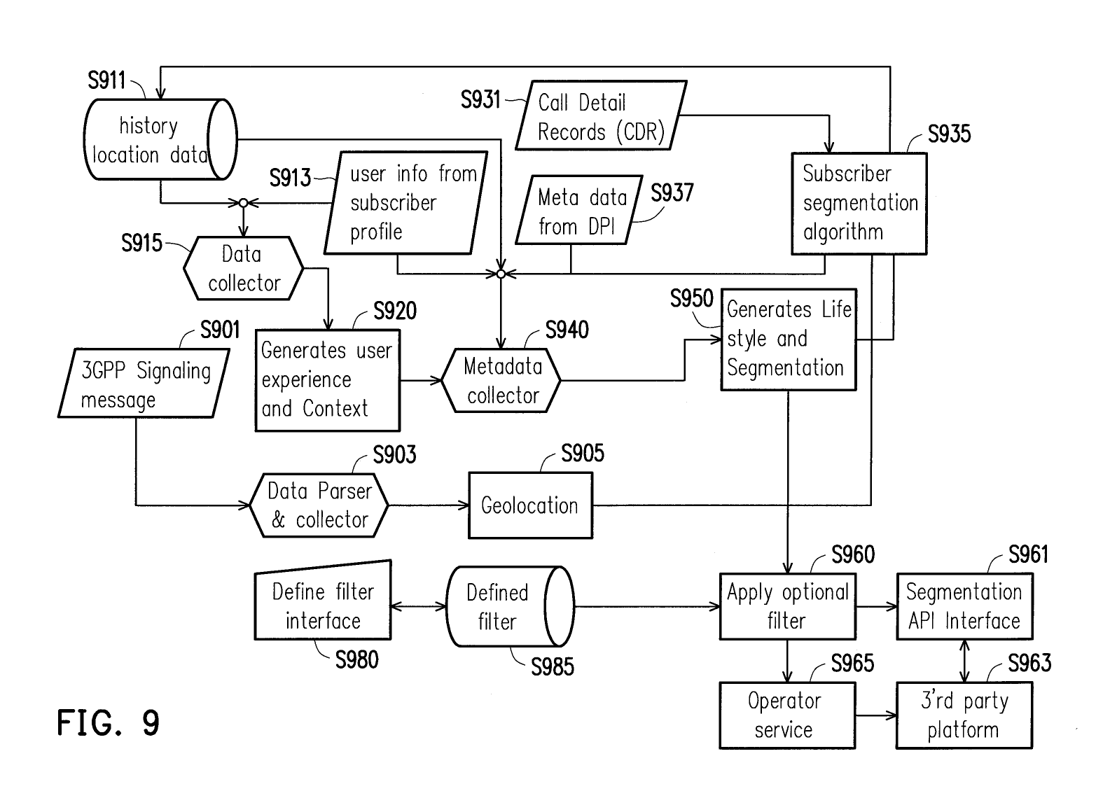

Furthermore, in order to make the embodiments of the disclosure easier to understand, an example of the flow chart of the network entity 100 or the server 600 are provided as below. FIG. 9 is a flow chart illustrating a method for determining segmentations of subscribers of the network entity 100 or the server 600. Referring to FIG. 9, in step S901, the network entity 100 receives the 3GPP signaling message of each subscriber, or the server 600 receives the 3GPP signaling message of each subscriber from the core network 690. Then, the 3GPP signaling message is putted into a data parser and a collector (step S903), to obtain the geolocation information (step S905). On the other hand, the history geolocation data of each subscriber (step S911) and the user information of each subscriber from the subscriber profile (step S913), such as gender, age, income, billing address, etc. . . . , are collected by a data collector (step S915). Then, the user experience (or QoE) and context (or moving behaviors) of each subscriber are generated according to the user information, the history geolocation data, and gelocation information (step S920). In addition, the CDRs of each subscriber may received by the network entity 100 or the server 600 (step S931) and be inputted into the segmentation algorithm (step S935), to obtain the targeted geolocation information of each subscriber such as the targeted entities related information and the location information of the targeted entities. Furthermore, the metadata (or service contents) of each subscriber are obtained from the DPI (step S937). Then, a metadata collector may collect the metadata, the geolocation information, the targeted geolocation information, and the history geolocation data (step S940). Next, the lifestyle and the segmentation of each subscriber are generated based on the metadata from the metadata collector (step S950). An option filter can be applied to control the output to segmentation API to third party platform such as the mobile advertising or market research (steps S960˜S963), or those lifestyle and segmentation of each subscriber would be applied to any other operator service (step S965). In addition, the mobile operators may configure a defined filter through a define filter interface to modify the parameters of the optional filter (step S980˜S985).

In view of the aforementioned descriptions, the present disclosure proposes a method for determining segmentations of the subscribers, a network entity using the same, a server using the same. The method comprises analyzing the signaling messages to determine the geolocation information of each subscriber, and analyzing the CDRs and the service contents of each subscriber to obtain the targeted geolocation information of each subscriber, so as to determine the segmentation of each subscriber. In the past, besides the network service revenue, the mobile operators never know how to create more revenue from data analytics, and the mobile operators made their competitor advantage become less and less toward companies providing the web portal. The present disclosure proposes an efficient and effective segmentation and location prediction method in telecom mobile network that covers 2G, 3G, 4G, and 5G networks. The proposed network entity, server, and methods utilize the engineering source data, but create huge business value in different industries. The present disclosure would be a cutting edge disclosure for location analytic and segmentation integrated with the mobile network operators.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items” and/or “the categories of items”, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A network entity, comprising:
a transceiver circuit, receiving a plurality of signaling messages of a plurality of subscribers, call detail records (CDRs) of the plurality of subscribers, and service contents of the plurality of subscribers;
a storage medium, storing user information of the plurality of subscribers; and
a processor, coupled to the transceiver circuit and the storage medium, and is configured for:
obtaining geolocation information of each of the plurality of subscribers by analyzing the plurality of signaling messages of each of the plurality of subscribers;
obtaining targeted geolocation information of each of the plurality of subscribers according to the CDRs and the service contents of each of the plurality of subscribers; and
determining segmentations of each of the plurality of subscribers according to the geolocation information, the targeted geolocation information, and the user information of each of the plurality of subscribers.

2. The network entity according to claim 1, wherein the targeted geolocation information of each of the plurality of subscribers comprises targeted entities related information of each of the plurality of subscribers, and the processor is further configured for:
obtaining the targeted entities related information of each of the plurality of subscribers according to the CDRs or the service contents of each of the plurality of subscribers, wherein one of the plurality of subscribers makes or receives a call to/from one of the targeted entities, or one of the service contents of the plurality of subscribers is provided by one of the targeted entities, and the one of the CDRs or the service contents of each of the plurality of subscribers corresponding to the one of the targeted entities is generated.

3. The network entity according to claim 2, wherein the targeted geolocation information of each of the plurality of subscribers comprises location information of the targeted entities of each of the plurality of subscribers, and the processor is further configured for:
obtaining the location information of the targeted entities of each of the plurality of subscribers according to the CDRs or the service contents of each of the plurality of subscribers; and
predicting visiting locations of each of the plurality of subscribers according to the location information of the targeted entities of each of the plurality of subscribers.

4. The network entity according to claim 3, the processor is further configured for:
refining a geolocation accuracy of the processor according to the location information of the targeted entities and the geolocation information of the plurality of subscribers in response to one of the plurality of subscribers is near one of the targeted entities of the subscriber.

5. The network entity according to claim 1, the processor is further configured for:
recording the geolocation information of each of the plurality of subscribers in a history geolocation data of each of the plurality of subscribers;
determining sticky locations of each of the plurality of subscribers which are clustering centers of the geolocation information of each of the plurality of subscribers according to the history geolocation data of each of the plurality of subscribers; and
identifying building categories nearby the sticky locations of each of the plurality of subscribers.

6. The network entity according to claim 5, the processor is further configured for:
determining frequently visiting locations of each of the plurality of subscribers according to the sticky locations of each of the plurality of subscribers; and
calculating commute data of each of the plurality of subscribers which each of the plurality of subscribers moves among the frequently visiting locations of each of the plurality of subscribers according to the history geolocation data of each of the plurality of subscribers.

7. The network entity according to claim 1, the processor is further configured for:
determining lifestyle of each of the plurality of subscribers according to the segmentations of each of the plurality of subscribers.

8. A method for determining segmentations of a plurality of subscribers, which is used by a network entity, and the method comprises:
receiving a plurality of signaling messages of the plurality of subscribers, call detail records (CDRs) of the plurality of subscribers, and service contents of the plurality of subscribers, and obtaining user information of the plurality of subscribers;
obtaining geolocation information of the plurality of subscribers by analyzing the plurality of signaling messages of the plurality of subscribers;
obtaining targeted geolocation information of each of the plurality of subscribers according to the CDRs and the service contents of each of the plurality of subscribers; and
determining segmentations of each of the plurality of subscribers according to the geolocation information, the targeted geolocation information, and the user information of each of the plurality of subscribers.

9. The method according to claim 8, wherein the targeted geolocation information of each of the plurality of subscribers comprises targeted entities related information of each of the plurality of subscribers, and the step of analyzing the CDRs and the service contents of each of the plurality of subscribers, to obtain the targeted geolocation information of each of the plurality of subscribers comprises:
obtaining targeted entities related information of each of the plurality of subscribers according to the CDRs or the service contents of each of the plurality of subscribers, wherein one of the plurality of subscribers makes or receives a call to/from one of the targeted entities, or one of the service contents of the plurality of subscribers is provided by one of the targeted entities, and the one of the CDRs or the service contents of each of the plurality of subscribers corresponding to the one of the targeted entities is generated.

10. The method according to claim 9, wherein the targeted geolocation information of each of the plurality of subscribers comprises location information of the targeted entities of each of the plurality of subscribers, and the step of analyzing the CDRs and the service contents of each of the plurality of subscribers, to obtain the targeted geolocation information of each of the plurality of subscribers comprises:
obtaining the location information of the targeted entities of each of the plurality of subscribers according to the CDRs or the service contents of each of the plurality of subscribers; and
predicting visiting locations of each of the plurality of subscribers according to the location information of the targeted entities of each of the plurality of subscribers.

11. The method according to claim 10, wherein after the step of obtaining the location information of the targeted entities of each of the plurality of subscribers according to the CDRs or the service contents of each of the plurality of subscribers, the method further comprises:
refining a geolocation accuracy according to the location information of the targeted entities and the geolocation information of the plurality of subscribers in response to one of the plurality of subscribers is near one of the targeted entities of the subscriber.

12. The method according to claim 8, wherein after the step of analyzing the plurality of signaling messages of the plurality of subscribers, to obtain the geolocation information of the plurality of subscribers, the method further comprises:
recording the geolocation information of each of the plurality of subscribers in a history geolocation data of each of the plurality of subscribers;
determining sticky locations of each of the plurality of subscribers which are clustering centers of the geolocation information of each of the plurality of subscribers according to the history geolocation data of each of the plurality of subscribers; and
identifying building categories nearby the sticky locations of each of the plurality of subscribers.

13. The method according to claim 12, wherein after the step of determining the sticky locations of each of the plurality of subscribers which are the clustering centers of the geolocation information of each of the plurality of subscribers according to the history geolocation data of each of the plurality of subscribers, the method further comprises:
determining frequently visiting locations of each of the plurality of subscribers according to the sticky locations of each of the plurality of subscribers; and
calculating commute data of each of the plurality of subscribers which each of the plurality of subscribers moves among the frequently visiting locations of each of the plurality of subscribers according to the history geolocation data of each of the plurality of subscribers.

14. A server, comprising:
a transceiver circuit, receiving a plurality of signaling messages of a plurality of subscribers, call detail records (CDRs) of the plurality of subscribers, and service contents of the plurality of subscribers, and user information of the plurality of subscribers;
a storage medium, storing the plurality of signaling messages of the plurality of subscribers, the CDRs of the plurality of subscribers, and the service contents of the plurality of subscribers, and the user information of the plurality of subscribers; and
a processor, coupled to the transceiver circuit and the storage medium, and is configured for:
obtaining geolocation information of the plurality of subscribers by analyzing the plurality of signaling messages of the plurality of subscribers;
obtaining targeted geolocation information of each of the plurality of subscribers according to the CDRs and the service contents of each of the plurality of subscribers; and
determining segmentations of each of the plurality of subscribers according to the geolocation information, the targeted geolocation information, and the user information of each of the plurality of subscribers.

15. The server according to claim 14, wherein the targeted geolocation information of each of the plurality of subscribers comprises targeted entities related information of each of the plurality of subscribers, and the processor is further configured for:
obtaining the targeted entities related information of each of the plurality of subscribers according to the CDRs or the service contents of each of the plurality of subscribers, wherein one of the plurality of subscribers makes or receives a call to/from one of the targeted entities, or one of the service contents of the plurality of subscribers is provided by one of the targeted entities, and the one of the CDRs or the service contents of each of the plurality of subscribers corresponding to the one of the targeted entities is generated.

16. The server according to claim 15, wherein the targeted geolocation information of each of the plurality of subscribers comprises location information of the targeted entities of each of the plurality of subscribers, and the processor is further configured for:
obtaining the location information of the targeted entities of each of the plurality of subscribers according to the CDRs or the service contents of each of the plurality of subscribers; and
predicting visiting locations of each of the plurality of subscribers according to the location information of the targeted entities of each of the plurality of subscribers.

17. The server according to claim 16, the processor is further configured for:
refining a geolocation accuracy of the processor according to the location information of the targeted entities and the geolocation information of the plurality of subscribers in response to one of the plurality of subscribers is near one of the targeted entities of the subscriber.

18. The server according to claim 14, the processor is further configured for:
recording the geolocation information of each of the plurality of subscribers in a history geolocation data of each of the plurality of subscribers;
determining sticky locations of each of the plurality of subscribers which are clustering centers of the geolocation information of each of the plurality of subscribers according to the history geolocation data of each of the plurality of subscribers; and
identifying building categories nearby the sticky locations of each of the plurality of subscribers.

19. The server according to claim 18, the processor is further configured for:
determining frequently visiting locations of each of the plurality of subscribers according to the sticky locations of each of the plurality of subscribers; and
calculating commute data of each of the plurality of subscribers which each of the plurality of subscribers moves among the frequently visiting locations of each of the plurality of subscribers according to the history geolocation data of each of the plurality of subscribers.

20. The server according to claim 14, the processor is further configured for:
determining lifestyle of each of the plurality of subscribers according to the segmentations of each of the plurality of subscribers.
